(19) United States
(12) Patent Application Publication
(10) Pub. No.: US 2012/0006776 A1
(43) Pub. Date: Jan. 12, 2012

(54) Panel Tamer

(76) Inventor: David Merritt, Baker, WV (US)

(21) Appl. No.: 12/776,086

(22) Filed: May 7, 2010

(51) Int. Cl. F16M 13/00; F16B 2/20

(52) U.S. Cl. 211/85.8; 211/41.15

(57) ABSTRACT

Apparatus for supporting a panel of plywood or sheetrock having a frame with left and right vertical tubes, a bottom horizontal tube attached to the sides and at the bottom ends of the vertical tubes, and a top horizontal tube attached to a side of the left and right vertical tubes and at their top ends. The bottom tube has a first cutout which is sized to receive a stud; and a clip having a second cutout with a width which is sized to receive a stud is attached to the top tube. The distance between the outside surfaces of the left and right vertical tubes is sized to fit between studs located on sixteen inch centers and the ends of the top and bottom horizontal tubes extend beyond the outside edges of the left and right vertical tubes to prevent the frame, when placed between two studs, from falling in between the studs.

### REFERENCE TO RELATED APPLICATIONS

This patent application claims the benefit of U.S. Provisional Application No. 61/214,198 filed on May 7, 2009, the disclosure of which is incorporated herein in its entirety by reference.

### BACKGROUND OF THE INVENTION

1. Field of the Invention

The present invention relates to the handling of plywood and sheetrock panels and more particularly to apparatus for transporting and positioning the panels on studs for nailing in place.

2. Description of Related Art

Handling of building panels such as plywood or sheetrock panels is known in the prior art. More specifically, by way of example, U.S. Pat. No. 5,322,403 to Herde discloses a weighted, pivotable base, an extensible shaft projecting from the base, and a carrier assembly adjustable transversely of and pivotable relative to the shaft and including releasable grippers for holding construction material on the shaft.

U.S. Pat. No. 4,135,655 to Brown discloses a bar-like member of telescopically arranged halves each having a lateral projection at its exposed opposite ends providing clamping jaws for engaging the side edges of sheet material where the telescopically arranged halve are spring urged together for closing the clamping jaws relative to the sheet material.

U.S. Pat. No. 7,387,293 to Boucher discloses an extension (or hoist) section coupled at one end to a support which can support a piece of drywall during installation. The base portion includes a pivot feature that serves to lift the drywall once it has been positioned on the support. The extension is adjustable to install drywall on a stud wall at various heights.

U.S. Pat. No. 6,244,810 to Reyes discloses a device for elevating a panel of drywall onto a ceiling by one person. The device includes a crank pivotally secured within the lower portion of a telescoping-member, a pulley secured to the upper portion of the telescoping member, and a cable to extend the telescoping member.

U.S. Pat. No. 4,630,838 to Stockton discloses an inverted U-shaped handle, having downwardly diverging legs whose ends are connected to an L-shaped elongated supporting bar upon which lower edges of sheet material rests.

U.S. Pat. No. 7,101,136 to Ray, et al. discloses a pair of panel-supporting legs of square tubing attached to side rails of a lift platform. Each leg is connected to the rails by an upper bracket at the top of the leg and a lower bracket at a middle location. A panel-receiving U-shaped channel is located on the opposite side of the legs, away from the rails.

U.S. Pat. No. 4,235,355 to Henry, et al. discloses a pair of brackets for engaging the two lower corners of a sheet of material and a flexible line connecting the pair of brackets to lift and carry the material.

U.S. Pat. No. 5,069,495 to Mears discloses a support for placing under the edge of a board to be lifted, a body portion attached to the support and a handle attached to the upper end of the body portion for lifting the device so that the board may be carried. The device further includes a holding mechanism for releasably holding the device in a stable raised position and at a desired height and a desired angle which are variable

U.S. Pat. No. 5,540,471 to Whitney discloses an elongated body having a handle portion, a shank portion and a weight-bearing or foot portion. The handle portion is canted inwardly toward a user and upwardly to the rear of the user to fit in the closed hand of a user. A shank portion of predetermined length is attached at one end to the handle portion and the weight-bearing portion is attached to the shank portion to support the workpiece along the bearing edge at the balance point.

U.S. Pat. No. 7,021,606 to Raycraft discloses a device for raising panels of sheetrock to upper portions of a wall and holding the panel in place while an individual nails or screws the sheetrock to the wall studs. A triangular sling-like attachment secures a panel of drywall being lifted by turning the winch. Another attachment on the top section allows the apparatus to lean against the studded wall.

U.S. Pat. No. 5,368,429 to Young discloses three telescoping elongated sections which telescope into one another and all telescoping into a non-telescoping elongated frame member. Three separate chain length segments not directly connected to one another act to raise and lower the telescoping sections. The first chain segment has its upper and lower end mounted to the upper and lower end of the first telescoping section. The second chain segment has its upper end connected to the upper end of the non-telescoping section and its lower end connected to the lower end of the second telescoping section. The third chain segment has its upper end connected to the upper end of the first telescoping section and its lower end connected to the lower end of the third telescoping section.

### SUMMARY OF THE INVENTION

In an exemplary embodiment of the present invention, there is disclosed apparatus for supporting a panel of plywood or sheetrock having a frame with left and right vertical tubes, a bottom horizontal tube attached to the sides and at the bottom ends of the vertical tubes, and a top horizontal tube attached to a side of the left and right vertical tubes and at their top ends. The bottom tube has a first cutout which is sized to receive a stud; and a clip having a second cutout with a width which is sized to receive a stud is attached to the top tube. The distance between the outside surfaces of the left and right vertical tubes is sized to fit between studs located on sixteen inch centers and the ends of the top and bottom horizontal tubes extend beyond the outside edges of the left and right vertical tubes to prevent the frame, when placed between two studs, from falling in between the studs.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 shows a perspective view of a frame for carrying a four foot by eight foot panel of plywood or sheetrock, or a four foot by twelve foot panel of sheetrock to a work area and positioning the panel on studs ready for nailing in place without measuring;

FIG. 2 is a front view of another embodiment of the frame for carrying a four foot by eight foot panel of plywood or sheetrock, or a four foot by twelve foot panel of sheetrock to a work area and positioning the panel on studs ready for nailing in place without measuring; and

FIG. 3 is an end view of the frame of FIG. 2.

### DESCRIPTION OF THE PREFERRED EMBODIMENT

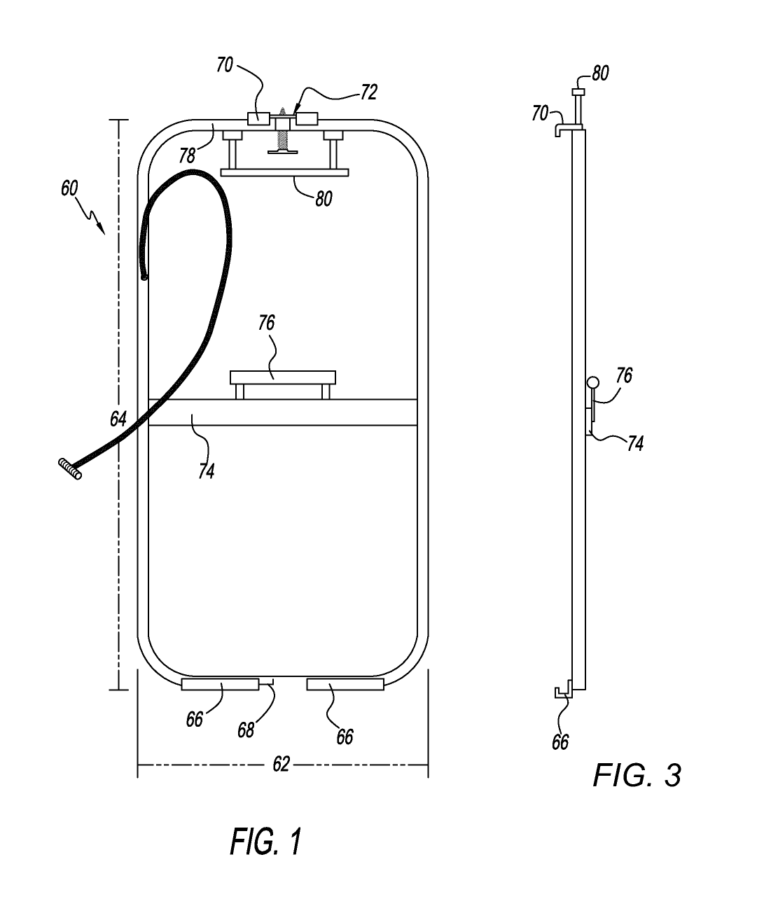

Referring to FIG. 1, there is disclosed a frame for carrying a four foot by eight foot panel of plywood or sheetrock, or a four foot by twelve foot panel of sheetrock to a work area and positioning the panel on studs ready for nailing in place without measuring.

The frame 10 has two vertical tubes 12, 14, a top tube 16 and a bottom tube 18 where each tube can be made of one inch square aluminum tubing. Each vertical tube has a length of forty seven and one half inches and the top and bottom tubes have a length of about sixteen inches. The top and bottom tubes are securely attached to the vertical tubes to form a square frame where the distance between the outside surfaces of the vertical tbes is fourteen and one quarter inches. This distance of fourteen and one quarter inches is the distance between two adjacent studs. Thus, the vertical tubes can be located between two adjacent studs. The ends 20 of the top and bottom tubes extend beyond the outside edges of the vertical tubes by about one and three quarters of an inch. Therefore, the vertical tubes of the frame can be placed between two adjacent studs but cannot fall down between the studs because the ends 20 of the top and bottom tubes extend beyond the stud spacing and rest of the studs.

The bottom tube 18 has a centrally located cutout 22 which has a length that is slightly greater than one and three quarters of an inch. This cutout can be formed by either cutting a notch in the side wall of the bottom tube or by attaching two short pieces of metal which are spaced apart by a distance that is slightly greater than one and three quarters of an inch to the side wall of the bottom tube. This cutout, when located on a stud, will center the bottom of the frame on that stud. Attached to the top tube 16 is a spring loaded clip 24 which allows the top of a panel of sheetrock or plywood to be clamped to the frame. The clip also has a one and three quarters of an inch cutout 26 which is located at the center of the frame. This cutout, when located on a stud, will center the top of the frame on that stud. The spring loaded clip 24 can swivel one hundred and eighty degrees and drop below the top of a panel of sheetrock being carried by the frame to allow the sheetrock to be located close to a ceiling.

A flat relatively rigid member of aluminum 28 which is slidably attached near the bottom of the vertical tubes has a centrally located handle 30 which is provide to lift the frame and a panel of sheetrock or plywood attached to the frame. The height of the slidable flat member 28 is adjustable and can be locked to a desired position with wing nuts which are threaded onto locking bolts. A second flat relatively rigid member of aluminum 32 is slidably attached near the top of the vertical tubes has a handle 34. This handle is provided to allow a worker's shoulder to rest against it.

A flexible strap 40 attached to vertical tube 12 or 14 is provide to sling over a workers shoulder and held in his opposing hand when the frame is being lifted on the workers back. An upper handle 34 at the top allows a worker to carry a panel of sheetrock or plywood with one arm thus freeing the other arm to allow a worker to lower a tailgate, or open a door without setting the sheet of drywall or plywood down

The bottom of the frame is adapted to receive detachable swivel type of wheels 36 which allows the frame and a panel of sheetrock or plywood to be rolled to a work site or used as a stand to provide a vertical cutting table by clamping the material to the top of the frame.

When nailing a four foot by eight foot panel of sheetrock horizontally to a wall, the four foot center line of the sheetrock is aligned with the center of cutouts 22, 26. Thus, four feet of the sheetrock extend out to the left of the center of the cutouts and four feet of the sheetrock extend out to the right of the center of the cutouts, and the cutouts 22, 26 are located at the center of the eight foot dimension of the sheetrock. Now, by placing the cutouts 22, 26 on a stud, the eight foot dimension of the sheetrock spans seven studs where the edges of the sheetrock are located at the centers of the studs at the ends of the sheetrock, and the panel of sheetrock can be easily and quickly nailed or screwed to the studs. In addition, the fourteen and one quarter inch spacing of the vertical tubes will fit between two adjacent studs that are located on sixteen inch centers and, therefore, by placing the frame between two studs the frame will also act as a lining tool when the panel of sheetrock is centered on it.

The bottom 18 allows a worker to install a lower panel of sheetrock raised off the floor properly and still allow the frame to be removed after nailing.

It is understood that the frame 10 can also be used to hold and position panels of sheetrock vertically as well as horizontally.

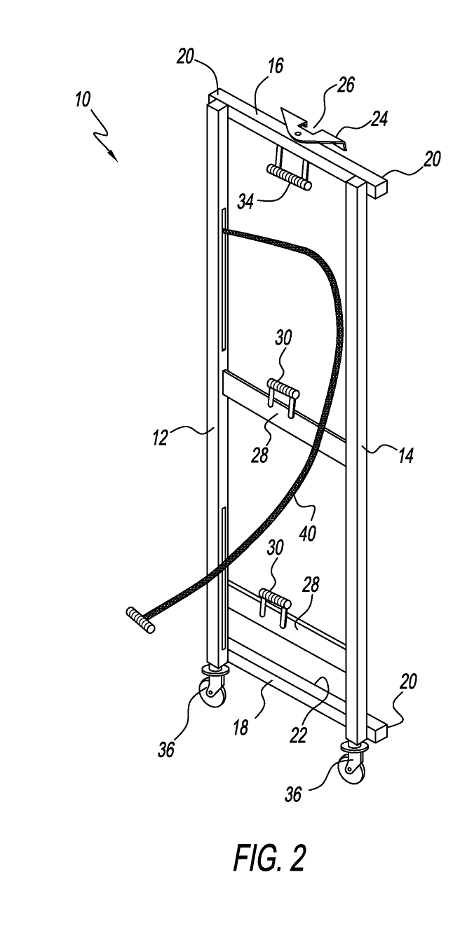

Referring to FIGS. 2 and 3, there is shown front and side views of another embodiment of the frame for carrying a four foot by eight foot panel of plywood or sheetrock, or a four foot by twelve foot panel of sheetrock to a work area and positioning the panel on studs ready for nailing in place. In this embodiment the frame 60 can be made of aluminum tubing which is bent to have a width 62 of nineteen and one half inches and a height 64 of forty seven and one half inches. Located at the bottom of the frame is a U shaped channel 66 with a width of about one inch for receiving a panel of plywood or sheetrock. The channel 66 is split to provide a centrally located cutout 68 having a width of slightly more that one and three quarters of an inch for receiving a stud.

Attached to the top member of frame 60 is a spring loaded clip 70 which allows the top of a panel of sheetrock or plywood to be clamped to the frame. The clip has a one and three quarters of an inch cutout 72 which is located at the center of the frame. This cutout, when placed on a stud, will center the top of the frame on that stud. The spring loaded clip 24 can swivel one hundred and eighty degrees and drop below the top of a panel of sheetrock being carried by the frame to allow the sheetrock to be located close to a ceiling. A relatively rigid member of aluminum 74 having a swingable handle 76 is securely attached near the bottom of the vertical members of the frame. A second relatively rigid member of aluminum 78 having a swingable handle 80 is securely attached near the top of the vertical members of the frame. When attaching panels of sheetrock or plywood to studs located on sixteen inch centers, the frame of FIGS. 2 and 3 can be use in substantially the same way as the frame of FIG. 1 is used.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are entitled.

What is claimed is:

1. Apparatus for supporting a panel of plywood or sheetrock comprising:
a frame having a left vertical tube, a right vertical tube, a bottom horizontal tube attached to a side of the left and right vertical tubes and at their bottom ends, and a top horizontal tube attached to a side of the left and right vertical tubes and at their top ends;
a first cutout having a width which is sized to receive a stud located in the bottom tube; and
a clip having a second cutout with a width which is sized to receive a stud attached to the top tube.

2. The apparatus of claim 1 wherein the distance between the outside surfaces of the left and right vertical tubes is sized to fit between studs located on sixteen inch centers.

3. The apparatus of claim 2 wherein the ends of the top and bottom horizontal tubes extend beyond the outside edges of the left and right vertical tubes to prevent the frame, when placed between two studs, from falling in between the studs.

4. The apparatus of claim 3 wherein the tubes of the frame are square.

5. The apparatus of claim 4 wherein the clip is spring loaded.

6. The apparatus of claim 5 wherein the clip can swivel one hundred and eighty degrees and drop below the top of a panel of sheetrock being carried by the frame to allow the sheetrock to be located close to a ceiling.

7. The apparatus of claim 6 wherein wheels can be removably attached to the frame.

8. The apparatus of claim 7 wherein the frame provides a vertical cutting and working surface.

9. The apparatus of claim 7 wherein a first flat relatively rigid member which is attached near the bottom of the vertical tubes has a centrally located handle which is provide to lift the frame and a panel of sheetrock or plywood that is attached to the frame.

10. The apparatus of claim 8 wherein the first flat relatively rigid member is slidably attached to the vertical tubes to be located at a desired height above the bottom tube.

11. The apparatus of claim 10 wherein the height of the slidable first flat member can be locked to a desired position with wing nuts which are threaded onto locking bolts.

12. The apparatus of claim 11 wherein a second handle is attached at the top of the vertical tubes to provide a shoulder rest for a worker's shoulder.

13. The apparatus of claim 12 wherein a strap located on the left or right vertical member is provided to sling over a workers shoulder and held in the workers hand when the frame is being lifted on the workers back.

14. The apparatus of claim 12 wherein the second handle allows a worker to carry a panel of sheetrock or plywood with one arm thus freeing the other arm to allow the worker to lower a tailgate, or open a door without setting the sheet of drywall or plywood down.
